(19) United States
(12) Patent Application Publication
(10) Pub. No.: US 2004/0153327 A1
(43) Pub. Date: Aug. 5, 2004

(54) Method and system providing customer product support

(76) Inventors: Janice Liu, Vancouver, WA (US); Teresa Huberty, Menlo Park, CA (US); Marie Tahir, San Diego, CA (US); Craig Oshima, Campbell, CA (US)

Correspondence Address: HEWLETT-PACKARD COMPANY, Intellectual Property Administration, P.O. Box 272400, Fort Collins, CO, 80527-2400, US

(21) Appl. No.: 10/355,551

(22) Filed: Jan. 31, 2003

(51) Int. Cl. G06F 17/60

(52) U.S. Cl. 705/1

(57) ABSTRACT

A method and system for providing customer support. Problem-type categories are provided to a user to select from for solving a product support problem. The user is also provided an interface to input a symptom related to the product support problem, in response to receiving the user's category selection. The user is provided a solution based on the symptom received from the user.

### TECHNICAL FIELD

The present invention relates to the field of customer product support. Specifically, embodiments of the present invention relate to a method and system for providing customer product support using a categorization technique.

### BACKGROUND ART

Any time a customer purchases a product (e.g., good or service) they hope that they will have no trouble installing the product and that no problems arise during use. However, no matter how well the seller designed the product it is inevitable that customers will face some problems.

Therefore, sellers conventionally provide their customers with product support avenues. For many years sellers provided telephone based customer support. However, while this provides customers with a sense that their problem is receiving attention, it can be very expensive to employ service agents who are knowledgeable about a full range of problems a user may face. Moreover, it can be very frustrating for a customer to be passed from one support agent to the next searching for someone who can provide help.

More recently, companies have begun to provide customer support via the Internet or the like. However, customers frequently get frustrated when solving customer support problems on-line. For example, some conventional systems inundate the customer with too many potential solutions that may or may not be related to the problem. Moreover, conventional customer support systems often fail to be user-friendly.

Thus, one problem with conventional methods and systems for providing customer support is that it is very expensive to employ human agents to field customer calls. Another problem with methods and systems for providing customer support is that the customer gets frustrated during the customer support process. Yet another problem with methods and systems for providing customer support is that the customer is inundated with too many potential solutions that may or may not be related to the problem.

### DISCLOSURE OF THE INVENTION

The present invention pertains to a method and system for providing customer support. The method comprises providing a plurality of categories to a user to select from for solving a product support problem. The categories may relate to various problem types. The user is also provided an interface to input a symptom related to the product support problem, in response to receiving the user's category selection. The user is provided a solution based on the symptom received from the user.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates an exemplary screen of support categories, according to an embodiment of the present invention.

FIG. 2 is an exemplary symptom input screen, according to an embodiment of the present invention.

FIG. 3 is an exemplary screen for refining a customer support problem solving process, according to an embodiment of the present invention.

FIG. 4 is an exemplary screen for problem solving process using categorization, according to an embodiment of the present invention.

FIG. 5 is an exemplary system for providing customer support using categorization, according to an embodiment of the present invention.

FIG. 6 is an exemplary flowchart illustrating steps of a process of providing customer support, according to an embodiment of the present invention.

FIG. 7 is an exemplary computer system that may serve as a platform for embodiments of the present invention.

### DETAILED DESCRIPTION OF THE INVENTION

In the following detailed description of embodiments of the present invention, a method and system for customer support using categorization, numerous specific details are set forth in order to provide a thorough understanding of the present invention. However, embodiments of the present invention may be practiced without these specific details or by using alternate elements or methods. In other instances well known methods, procedures, components, and circuits have not been described in detail as not to unnecessarily obscure aspects of the present invention.

Embodiments of the present invention provide customer support using categorization. In so doing, the customer receives a more user-friendly experience than conventional customer support techniques allow. Moreover, as embodiments of the present invention may be web-based, the expense of human agents fielding every customer call is not required.

The inventors have discovered that in some conventional systems for product support a customer is forced to navigate through numerous pages in order to receive any positive feedback on his or her problem. Moreover, conventionally the customer may be prompted to supply information such as the product's model number that the customer does not have readily at hand. Along the way, the customer can get frustrated if it appears that no progress is being made to solve the problem in conventional methods. The inventors have further discovered that some customers prefer to approach their customer support issue with a problem-oriented approach. Embodiments of the present invention provide customer support using a problem or symptom oriented approach.

Thus, embodiments of the present invention provide a method and system for providing customer support that does not require expensive human agents to field customer calls. Embodiments of the present invention provide user friendly customer support. Embodiments of the present invention filter out documents that do not help the customer solve their problem, while preserving those that are on point.

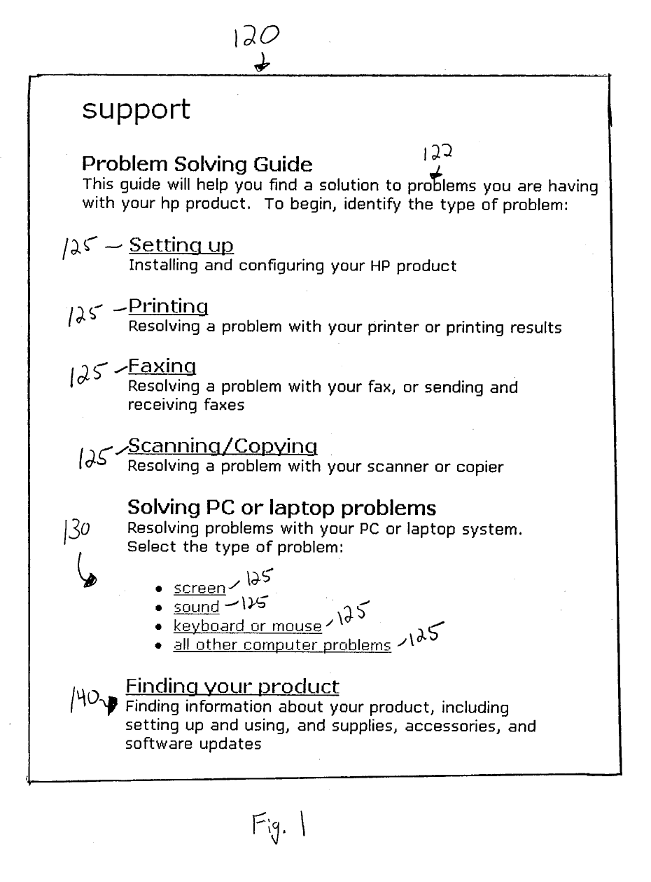

FIG. 1 is an exemplary screen 120 made available to a user, in one embodiment of the present invention. The screen 120 has a message 122 to prompt the user to identify the type of problem from a list of multiple problem types 125. The problem types 125 in this example are “setting up”, “printing”, “Faxing”, and “scanning/copying”. However, many other categories could be used. In this example, any of the categories can relate to problems of any type of product. For example, the problem type of “setting up” pertains to any type of product. Moreover, the other categories also can pertain to any type of product. For example, if the customer selects the “printing” problem type 125, the solution could be connected to the printer or driver software on the host computer, for example. In this fashion, embodiments of the present invention provide the customer a solution based on how the user intuitively thinks about the problem they face. If the customer were required to enter a product type initially, as conventional systems require, the problem could be misdiagnosed. For example, the customer might assume the printer was the problem and enter the printer's product information, in a conventional system. However, if the problem were in fact with the host driver, the conventional system would likely misdiagnose the problem.

Still referring to FIG. 1, the screen 120 may optionally allow problem type based input directed to a category of devices. For example, screen 120 has a region 130 dedicated to personal computer or laptop problems. In this case, the problem type categories are, “screen”, “sound”, “keyboard or mouse”, and “other”. By providing problem type based categories to select from, the customer gets a sense that progress is being made diagnosing their problem, in contrast to conventional systems that require the user to drill down several pages by entering product names and serial numbers.

The exemplary screen 120 of FIG. 1 also has a region 140 for finding information about a product, such as setting up and using. Thus, this embodiment provides users with the option of solving their customer support issue in different manners. It will be understood that the region 140 is optional and that other optional regions may be included within screen 120.

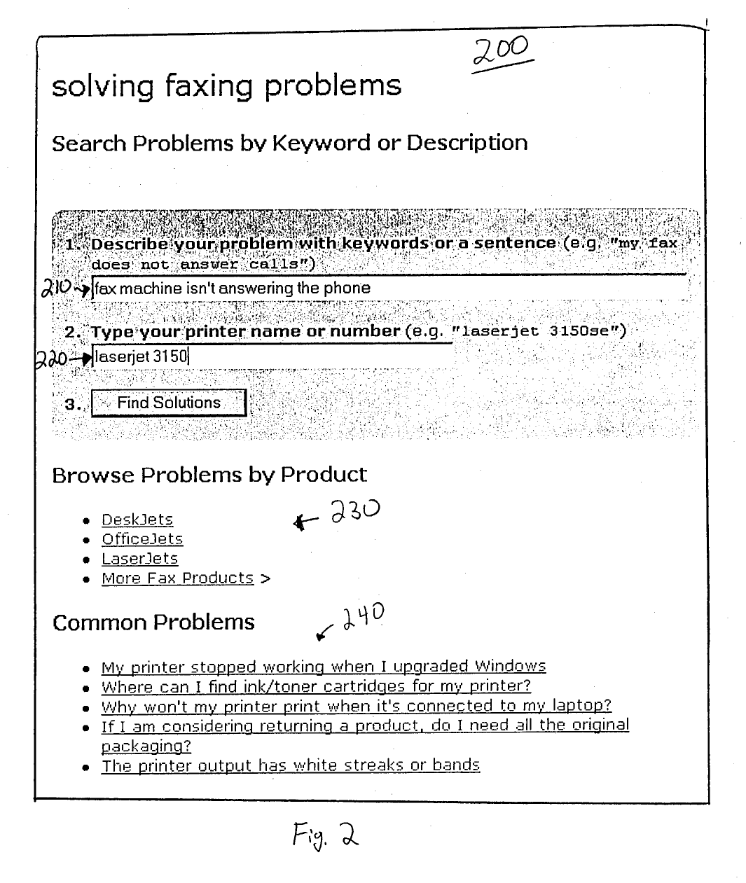

Referring now to FIG. 2, after the customer's selection of a problem type is received, a screen such as the exemplary symptom screen 200 is provided by an embodiment of the present invention. The symptom screen 200 provides symptom description field 210 giving the customer an opportunity to describe the problem with keywords or a description, for example. The symptom screen 200 may also provide a product field 220 to enter product information. In this example, the customer is allowed to enter a printer name or number. The entrance of information in either symptom description field 210 or product field 220 may be optional. In this fashion, the user is allowed to solve the problem in the fashion that is most convenient for the user.

Still referring to FIG. 2, the customer may browse problems by product in the product region 230. Alternatively, the customer may select from among the common problems in a common problem region 240 of the exemplary screen 200. Thus, the user is allowed to select from common Faxing problems or enter a symptom without having to go through screen after screen.

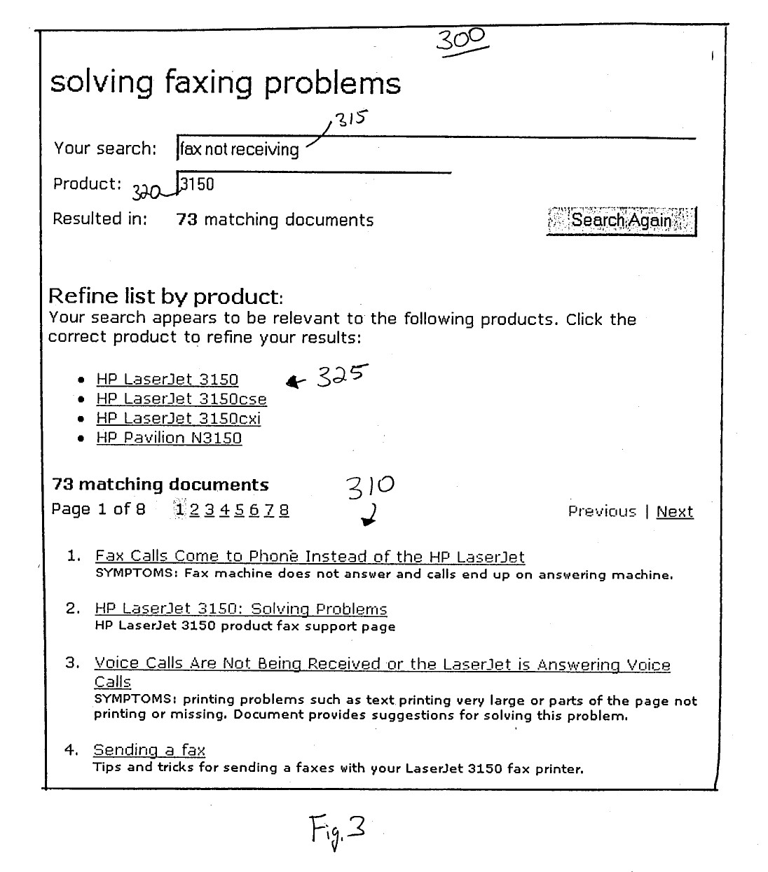

After receiving the customer's symptom (e.g., FIG. 2, 210), a screen such as shown in FIG. 3 is displayed, in an embodiment of the present invention. This exemplary screen 300 or the like may also be displayed in response to a user selecting one of the common problems (e.g., FIG. 2, 240) or browsing by problem (FIG. 2, 230). This exemplary screen 300 contains a list of documents 310 relating to the solution of the customer's problem. Some of the documents 310 are labeled by symptom, although this is not required. For example, the first document 310 has a description of “SYMPTOMS: Fax machine does not answer and calls end up on answering machine.”

This screen 300 also allows the customer to further refine their search by entering new information in boxes 315 and 320, if desired. The customer is also allowed to refine their search based on product by selecting a product in area 325. An embodiment of the present invention determines relevant products to display in area 325 based on the information received from the customer, such as the symptom. This can be very useful for a customer who is unsure as to which device in the system is causing the problem or who will recognize the product name or number upon seeing it but does not recall it and hence cannot enter it from memory.

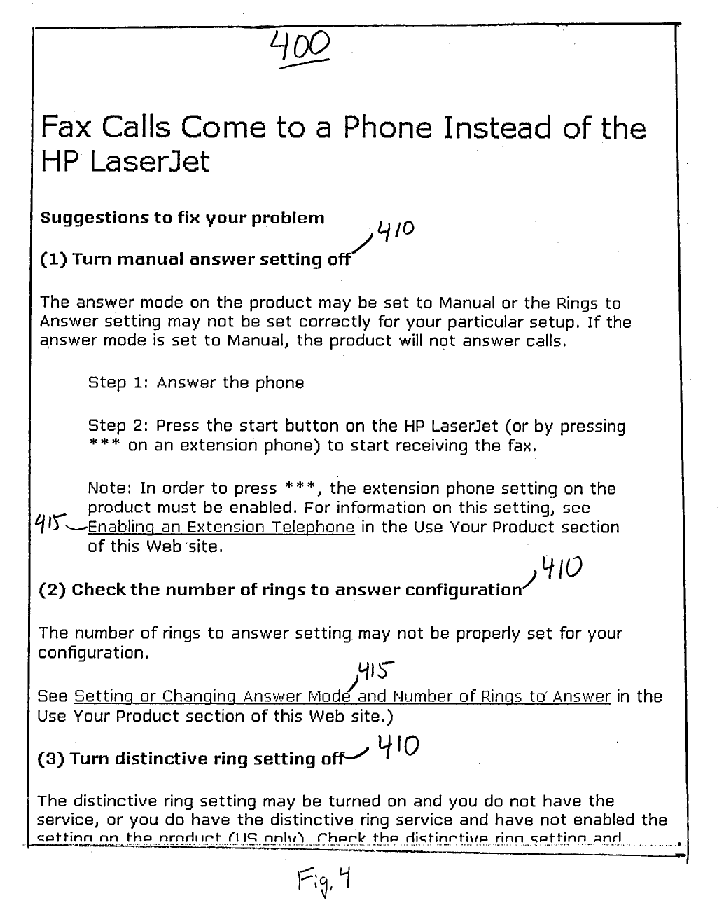

FIG. 4 illustrates an exemplary problem solution page 400 that is displayed in response to the customer's selecting a document 310 from FIG. 3. The exemplary solution page 400 provides several suggestions 410 to fix the problem. Also provided are links 415 to other pages.

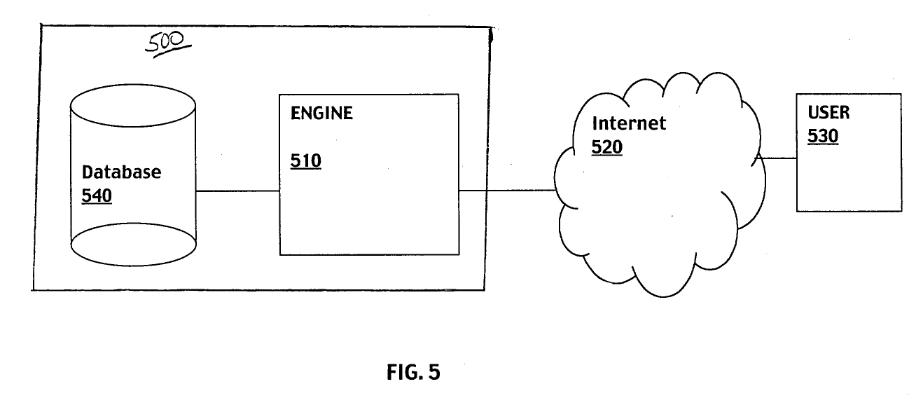

FIG. 5 is an exemplary system 500 (and associated elements) for providing customer support using categorization. The exemplary system 500 has an engine 510 that is operable to provide a plurality of categories to a user to select from for solving a product support problem. Exemplary categories are shown in FIG. 1, although other possibilities exist.

The exemplary system 500 also has a database 540 of documents coupled to the engine 510. The documents describe solutions to product support related problems. An exemplary document is shown in FIG. 4.

To facilitate symptom-based support, the documents may be tagged by symptom. Moreover, the document titles and descriptions may be symptom based. In this fashion, the engine 510 is able to search for a solution based on the symptom received from the customer 530.

The engine 510 may be coupled to the Internet 520 or the like such that a customer/user 530 may interface with the exemplary system 500. The user 530 may use a personal computer or the like.

The engine 510 is further operable to provide an opportunity to the user 530 to input a symptom related to the product support problem. This may be implemented as seen in FIG. 2, for example. The engine 510 is also operable to provide a solution based on the symptom received from the user 530. For example, the engine 510 returns a document, in response to a user selecting the document from a list of possible documents. The engine 510 is able to limit the number of documents from which the user selects by filtering out documents that will not be useful, based on the symptom.

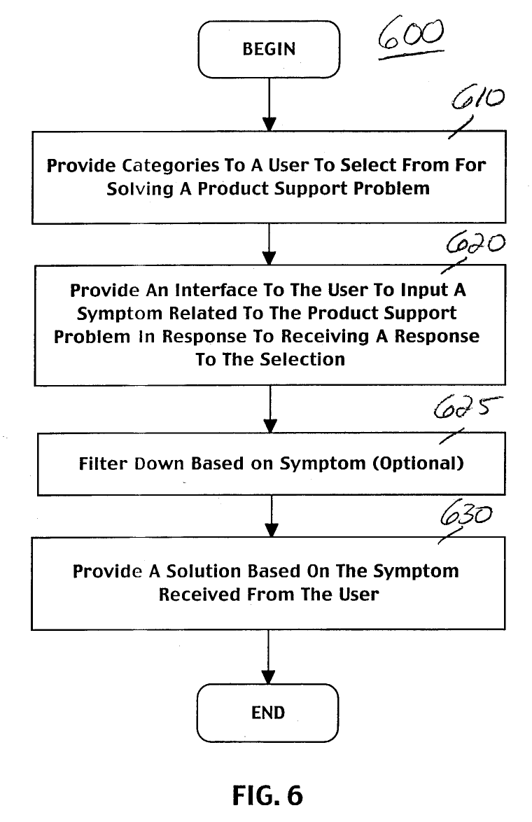

An embodiment of the present invention provides for a method for providing customer support. Steps of process 600 of FIG. 6 may be stored as instructions on a computer readable medium and executed on a general-purpose processor. In step 610, a plurality of categories are providing to a user to select from for solving a product support problem. Step 610 optionally allows the user to input product information related to the product support problem.

In step 620, the user is provided an interface to input a symptom related to the product support problem. This step is in response to receiving selection from the user, in step 610.

In optional step 625, the user is providing a list of products that may be related to the product support problem based on the symptom. For example, based on the symptom, the engine (FIG. 5, 510) may determine (e.g., filter) that the problem is most likely related to a few products. The engine 510 can display them as in area 325 of FIG. 3. Then, the user can select (e.g., filter) one of the products such that the matching document list is reduced. In this fashion, the user is allowed to filter a list of returned solutions by product.

In step 630, the user is provided a solution based on the symptom the user input in step 620. Thus, it is possible for the user to receive a solution without ever entering a product name or number. In some cases, that information will be entered, but its entry is later in the process.

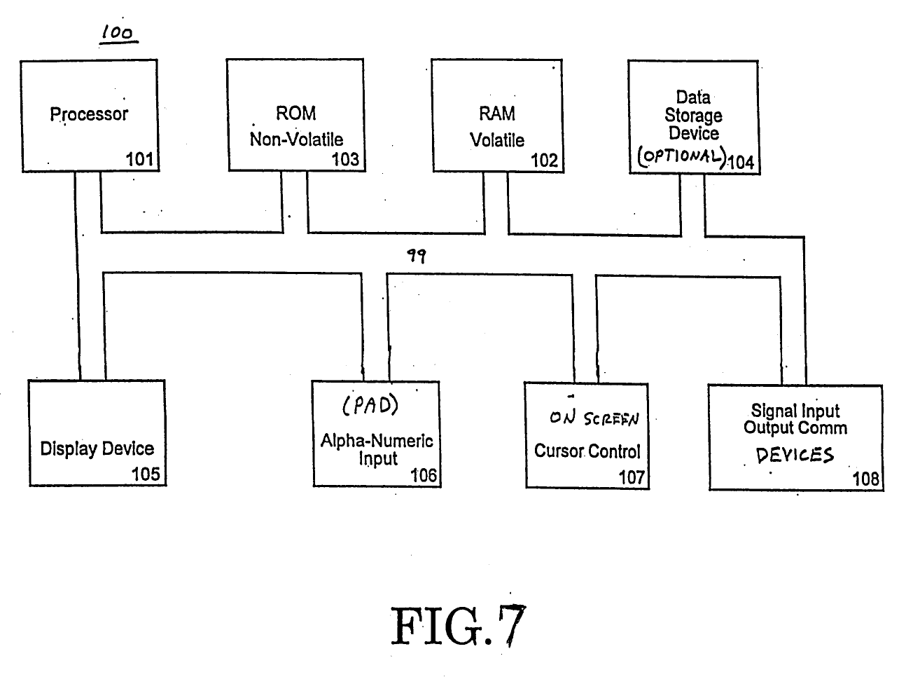

With reference now to FIG. 7, portions of embodiments of the present invention are comprised of computer-readable and computer-executable instructions that reside, for example, in computer-usable media of a computer system. For example, computer system 100 may be used as a platform for engine 510 and database 540. FIG. 7 illustrates an exemplary computer system 100 used to perform a method in accordance with embodiments of the present invention. It is appreciated that system 100 of FIG. 7 is exemplary only in that embodiments of the present invention can operate within a number of different computer systems including general purpose networked computer systems, embedded computer systems, and stand alone computer systems. Additionally, computer system 100 of FIG. 7 is well adapted to having computer readable media such as, for example, a floppy disk, a compact disc, and the like coupled thereto. Such computer readable media is not shown coupled to computer system 100 in FIG. 7 for purposes of clarity.

System 100 of FIG. 7 includes an address/data bus 99 for communicating information, and a central processor unit 101 coupled to bus 99 for processing information and instructions. System 700 also includes data storage features such as a computer usable volatile memory 102, e.g., random access memory (RAM), coupled to bus 99 for storing information and instructions for central processor unit 101, computer usable non-volatile memory 103, e.g. read only memory (ROM), coupled to bus 99 for storing static information and instructions for the central processor unit 101, and an optional data storage unit 104 (e.g., a magnetic or optical disk and disk drive) coupled to bus 99 for storing information and instructions.

With reference still to FIG. 7, system 100 of embodiments of the present invention also includes an optional alphanumeric input device 106 including alphanumeric and function keys is coupled to bus 99 for communicating information and command selections to central processor unit 101. System 100 also optionally includes a cursor control device 107 coupled to bus 99 for communicating user input information and command selections to central processor unit 101. System 100 of the present embodiment also includes an optional display device 105 coupled to bus 99 for displaying information. Signal input/output communication device(s) 108 coupled to bus 99 is connected to a network (e.g., Internet 520) and controls the flow of information over the network.

While the present invention has been described in particular embodiments, it should be appreciated that the present invention should not be construed as limited by such embodiments, but rather construed according to the below claims.

We claim:

1. A method for providing customer support comprising:
a) providing a plurality of categories to a user to select from for solving a product support problem by type of problem;
b) providing an interface to said user to input a symptom related to said product support problem in response to receiving a category selection from said user; and
c) providing a solution based on said symptom received from said user.

2. The method of claim 1, wherein said a) further comprises allowing said user to input product information related to said product support problem.

3. The method of claim 1, wherein said b) comprises providing a list of common problems for said user to select from.

4. The method of claim 1, wherein said b) comprises providing a list of common problems and a symptom description field.

5. The method of claim 1, wherein a category of said plurality of categories relates to problems of multiple types of products.

6. The method of claim 1, further comprising providing to said user a list of products that may be related to said product support problem based on said symptom.

7. The method of claim 1, wherein said user is not required to enter a product number to receive said solution.

8. The method of claim 1, wherein said user is not required to enter a product type to receive said solution.

9. A system for providing customer support comprising:
an engine operable to provide a plurality of problem-type categories to a user to select from for solving a product support problem;
a process on said engine which provides an opportunity to said user to input a symptom related to said product support problem, and wherein said engine provides a solution based on said symptom.

10. The system of claim 10, further comprising:
a database of documents coupled to said engine, said documents describing solutions to product support related problems; and
wherein said engine is further operable to search said database for said solution.

11. The system of claim 10, wherein said documents are tagged by symptom.

12. The system of claim 10, wherein titles of said documents are symptom based.

13. The system of claim 10, wherein descriptions of said documents are symptom based.

14. A computer readable medium having stored thereon instruction which when executed on a general purpose processor implement a method for providing customer product support, said method comprising:
a) providing a plurality of problem type categories to a user to select from for solving a product support problem;
b) allowing said user to choose between entering a symptom and entering product information; and
c) providing to said user a solution based on said user-entered information in said b) and a problem type category selection in said a).

15. The computer readable medium of claim 14, wherein said b) of said method further comprises providing a list of common problems for said user to select from.

16. The computer readable medium of claim 14, wherein said method further comprises providing a list of products that may be related to said product support problem based on said symptom.

17. The computer readable medium of claim 14, wherein a category of said plurality of categories provides resolutions to problems of multiple types of products.

18. The computer readable medium of claim 14, wherein said plurality of categories are dedicated to a single product type.

19. The computer readable medium of claim 14, wherein said user is not required to enter a product number to receive said solution.

20. The computer readable medium of claim 14, wherein said user is not required to enter a product type to receive said solution.
